(19) United States
(12) Patent Application Publication
(10) Pub. No.: US 2007/0147096 A1
(43) Pub. Date: Jun. 28, 2007

(54) Power source device and apparatus using same

(76) Inventors: Fujio Kizaki, Mie (JP); Tsuneo Tsuji, Mie (JP)

Correspondence Address: RATNERPRESTIA, P.O. BOX 980, VALLEY FORGE, PA, 19482, US

(21) Appl. No.: 10/582,454

(22) PCT Filed: Dec. 10, 2004
(86) PCT No.: PCT/JP04/18458

§ 371 Date: Jun. 12, 2006

(30) Foreign Application Priority Data
Dec. 16, 2003 (JP) 2003-417779

(51) Int. Cl. H02M 3/335

(52) U.S. Cl. 363/19

(57) ABSTRACT

A power source device includes a transformer having a first winding and a second winding, an oscillator self-oscillating with using the first winding of the transformer and supplying an oscillating voltage to the first winding, a rectifier for converting an AC voltage output from the second winding into a DC voltage and outputting the DC voltage, first and second output terminals for outputting the DC voltage output from the rectifier, and a diode connected between the first and second output terminals of the rectifier so that a polarity of the diode is reverse to a polarity of the DC voltage. The first and second output terminals are connected with a load charged with an electric charge having a polarity reverse to the polarity of the DC voltage. This power source device can start operating easily without a Zener diode having a high Zener voltage.

### TECHNICAL FIELD

The present invention relates to a power source device and an apparatus, such as a laser printer and a photocopier, including the device.

### BACKGROUND ART

FIG. 4 is a circuit diagram of an apparatus, such as a laser printer or a photocopier, including conventional power source device 101. In this apparatus, power source device 101 supplies an electric charge to chargeable body 7 from output terminal 1c via electrode 6. Direct current (DC) power source 15 for supplying an electric power to power source device 101 and switch 14 for controlling the supply of the electric power from DC power source 15 are connected to input terminals 101a and 101b of power source device 101.

The circuit of power source device 101 will be described below. Self-excited oscillator 4 oscillates by self excitation with the electric power supplied from DC power source 15 and inductances of windings 201 and 202 of step-up transformer 2. Step-up transformer 2 raises an oscillating voltage generated by the self excitation, and outputs an alternating current (AC) voltage from secondary winding 203. Rectifier 3 converts the AC voltage output from secondary winding 203 of step-up transformer 2 into a DC voltage, and outputs the DC voltage it to output terminals 101c and 101d of power source device 101. Zener diode 105 is connected between rectifier 3 and output terminal 101d of power source device 101 so that an output current of power source device 101 corresponds to a forward current of Zener diode 105.

The conventional power source device is disclosed in Japanese Patent Laid-Open Publications Nos. 06-232087 and 08-115132.

In the conventional power source device 101, a discharge current flows through rectifier diode 8 if chargeable body 7 is charged with a voltage which has a polarity reverse to the polarity of the voltage output from power source device 101 and which is higher than a Zener voltage of Zener diode 105. If the discharge current flows through rectifier diode 8 while switch 14 cuts a power to power source device 101, diode 8 is turn on and short-circuits both ends of secondary winding 203 of step-up transformer 2. This prevents the self-exited oscillator 4 from oscillating with using the inductances of windings 201 and 202 of step-up transformer 2, and prevents power source device 101 from starting operating.

In order to avoid the above phenomenon, the Zener voltage of Zener diode 105 ranges from 100 to 800 volts according to a voltage charged on chargeable body 7. Zener diodes each having such a high Zener voltage are expensive, and requires a space for electrical insulation, hence preventing apparatuses from having small sizes. In addition, Zener diode 105 produces a high forward voltage, thus decreasing the output voltage of power source device 101 and reduces an efficiency of power source device 101.

### SUMMARY OF THE INVENTION

A power source device includes a transformer having a first winding and a second winding, an oscillator self-oscillating with using the first winding of the transformer and supplying an oscillating voltage to the first winding, a rectifier for converting an AC voltage output from the second winding into a DC voltage and outputting the DC voltage, first and second output terminals for outputting the DC voltage output from the rectifier, and a diode connected between the first and second output terminals of the rectifier so that a polarity of the diode is reverse to a polarity of the DC voltage. The first and second output terminals are connected with a load charged with an electric charge having a polarity reverse to the polarity of the DC voltage.

This power source device can start operating easily without a Zener diode having a high Zener voltage.

### BRIEF DESCRIPTION OF DRAWINGS

FIG. 1 is a circuit diagram of an apparatus including a power source device according to Exemplary Embodiment 1 of the present invention.

FIG. 2 is a circuit diagram of an apparatus including a power source device according to Exemplary Embodiment 2 of the invention.

FIG. 3 is a circuit diagram of an apparatus including a power source device according to Exemplary Embodiment 3 of the invention.

FIG. 4 is a circuit diagram of an apparatus including a conventional power source device.

### REFERENCE MARKS IN THE DRAWINGS

1 Power Source Device
2 Step-Up Transformer
3 Rectifier
4 Self-Excited Oscillator
5 Zener Diode
10 Diode

### DETAILED DESCRIPTION OF THE PREFERRED EMBODIMENTS

### Exemplary Embodiment 1

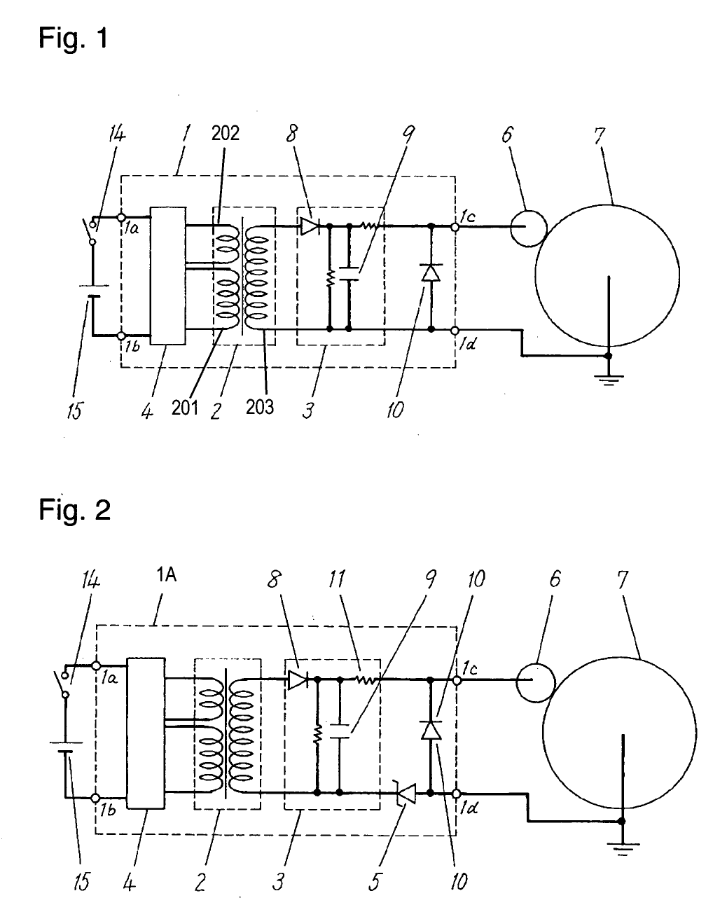

FIG. 1 is a circuit diagram of an apparatus, such as a laser printer or an electro-photographic device, including power source device 1 according to Exemplary Embodiment 1 of the present invention. Power source device 1 supplies an electric charge from output terminals 1c and 1d to a load, chargeable body 7, via electrode 6. Direct current (DC) power source 15 for supplying electric power to power source device 1 and switch 14 for controlling the supply of the electric power from DC power source 15 are connected to input terminals 1a and 1b of power source device 1.

The circuit of power source device 1 will be described below. Self-excited oscillator 4 oscillates by self excitation with using the electric power supplied from DC power source 15 and inductances of windings 201 and 202 of step-up transformer 2, and supplies an oscillating voltage to winding 201. Step-up transformer 2 raises the oscillating voltage, and outputs the voltage to an alternating current (AC) voltage from secondary winding 203. Rectifier 3 converts the AC voltage output from secondary winding 203 of step-up transformer 2 into a DC voltage, and outputs the DC voltage to input terminals 1c and 1d of power source device 1. Diode 10 is connected between output terminals 1c and 1d of rectifier 3. Rectifier 3 is a half-wave rectification circuit including rectifier diode 8 and rectifying capacitor 9. Output terminal 1d of power source device 1 is connected to a ground, and a cathode of rectifier diode 8 is connected to output terminal 1c, so that a positive potential appears at output terminal 1c.

When chargeable body 7 is charged with a negative electric charge, and switch 14 is turned off to cause self-excited oscillator 4 not to operate, a negative potential of the negative charge charged on chargeable body 7 is supplied to output terminal 1c. This negative potential turns on diode 10 and causes the electric charge stored in chargeable body 7 to discharge through diode 10 to the ground. This prevents a current from flowing through rectifier diode 8, thereby avoiding to prevent power source device 1 from starting operation. A forward voltage of diode 10 is preferably lower than that of rectifier diode 8 in order to allow the negative potential to turn on diode 10.

An impedance of secondary winding 203 of step-up transformer 2 is connected in series to diode 8. This connection allows the electric charge stored at chargeable body 7 to discharge through diode 10 to the ground even if diode 10 has the forward voltage identical to that of rectifier diode 8.

### Exemplary Embodiment 2

FIG. 2 is a circuit diagram of an apparatus, such a laser printer or an electro-photographic device, including power source device 1A according to Exemplary Embodiment 2. Components identical to those shown of Embodiment 1 in FIG. 1 are denoted by the same reference numerals, and their details will be omitted. In the apparatus shown in FIG. 2, Zener diode 5 having a Zener voltage ranging from several volts to several tens of volts is connected between rectifier 3 and diode 10. The Zener voltage of Zener diode 5 is higher than a forward voltage of diode 10.

When chargeable body 7 is charged with a negative electric charge and switch 14 is turned off to cause self-excited oscillator circuit 4 not to operation, a negative potential of the negative charge stored at chargeable body 7 is supplied to output terminal 1c. The Zener voltage of Zener diode 5 is higher than the forward voltage of diode 10, hence allowing this negative charge stored at chargeable body 7 to discharge through diode 10 to a ground regardless of the characteristics of diode 10 and rectifier diode 8. This prevents a current from flowing through rectifier diode 8, thereby avoiding to prevent power source device 1A from starting operation. The Zener voltage of Zener diode 5 can be a low voltage ranging from several volts to several tens of volts even though the negative charge stored at chargeable body 7 is several hundred of volts.

### Exemplary Embodiment 3

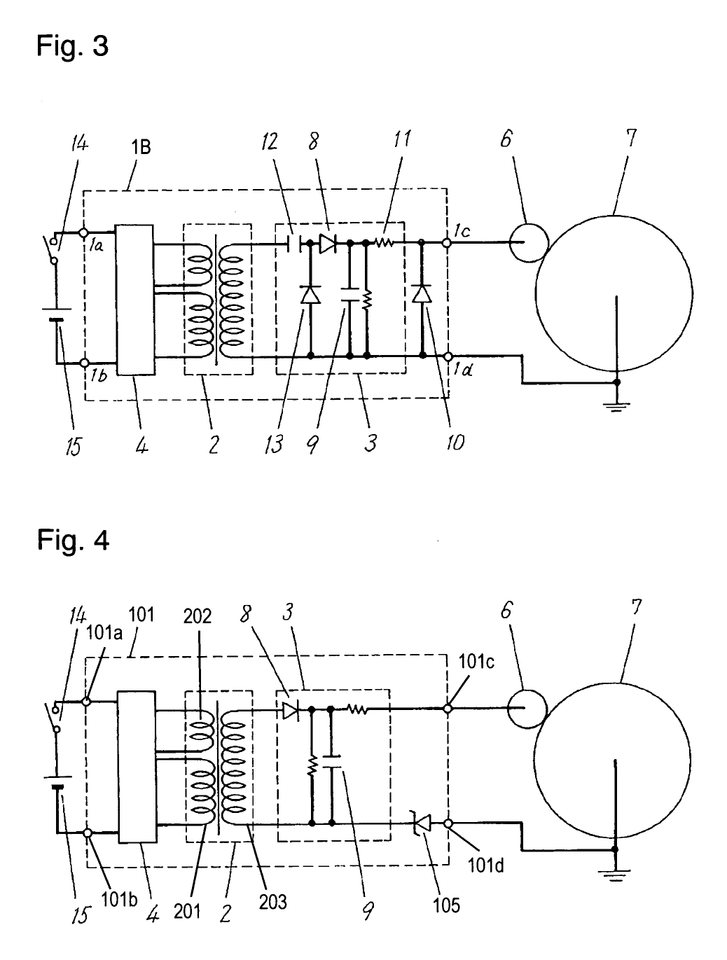

FIG. 3 is a circuit diagram of an apparatus, such as a laser printer or an electro-photographic device, including power source device 1B according to Exemplary Embodiment 3 of the present invention. Components identical to those of Embodiment 1 shown in FIG. 1 are the same reference numerals, and their details will be omitted. Instead of rectifier 3 shown in FIG. 1, power source device 1B includes rectifier 3A including capacitor 12 and rectifier diode 13 which provide a voltage-doubler rectifier.

When chargeable body 7 is charged with a negative electric charge and switch 14 is turned off to cause self-excited oscillator 4 not to operate, a negative potential of the negative charge stored at chargeable body 7 is supplied to output terminal 1c. Rectifier 3A is the voltage doubler rectifier, and includes diodes 8 and 13 connected in series in a line through which the negative charge can be discharged. However, the negative charge is discharged only through diode 10 since a voltage twice the forward voltage of a single diode is required in order to cause the discharge current to flow through both diodes 8 and 13. This prevents a current from flowing through diodes 8 and 13, thereby avoiding to prevent power source device 1B from starting operation. Rectifier 3A is the voltage doubler rectifier, however, may be a voltage multiplier, such as a voltage tripler or a voltage quadrupler. The higher the voltage is, the stronger the rectifier avoids to prevent power source device 1B from starting operation

### INDUSTRIAL APPLICABILITY

A power source device according to the present invention starts operating reliably even if being connected to a load having an electric charge of a polarity reverse to the polarity of a voltage output from the device, hence being suitable for a laser printer and a photocopier

1. A power source device comprising:
a transformer having a first winding and a second winding;
an oscillator self-oscillating with using the first winding of the transformer, and supplying an oscillating voltage to the first winding, the transformer generating an alternating current (AC) voltage at the second winding responsive to the oscillating voltage supplied from the first winding;
a rectifier for converting the AC voltage output from the second winding into a direct current (DC) voltage, and outputting the DC voltage;
first and second output terminals for outputting the DC voltage output from the rectifier; and
a diode connected between the first and second output terminals of the rectifier so that a polarity of the diode is reverse to a polarity of the DC voltage,
wherein the first and second output terminals are connected with a load charged with an electric charge having a polarity reverse to the polarity of the DC voltage.

2. The power source device according to claim 1, further comprising a Zener diode connected between the diode and the rectifier.

3. The power source device according to claim 1, wherein the rectifier comprises a voltage multiplier rectifier.

4. An apparatus comprising:
a load charged with an electric charge; and
a power source device including
a transformer having a first winding and a second winding,
an oscillator self-oscillating with using the first winding of the transformer, and supplying an oscillating voltage to the first winding, the transformer generating an alternating current (AC) voltage at the second winding responsive to the oscillating voltage supplied from the first winding,
a rectifier for converting the AC voltage output from the second winding into a direct current (DC) voltage, and outputting the DC voltage,
first and second output terminals for outputting the DC voltage output from the rectifier and connected to the load, and
a diode connected between the first and second output terminals of the rectifier so that a polarity of the diode is reverse to a polarity of the DC voltage,
wherein the electric charge of the load has a polarity reverse to the polarity of the DC voltage.

5. The apparatus according to claim 4, wherein the power source device further includes a Zener diode connected between the diode and the rectifier.

6. The apparatus according to claim 4, wherein the rectifier comprises a voltage multiplier rectifier.
